(19) United States
(12) Patent Application Publication
(10) Pub. No.: US 2006/0242434 A1
(43) Pub. Date: Oct. 26, 2006

(54) Portable device with motion sensor

(76) Inventor: Tsung-Jen Lee, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/111,899

(22) Filed: Apr. 22, 2005

(51) Int. Cl. G06F 1/24; G06F 1/26

(52) U.S. Cl. 713/300; 713/100

(57) ABSTRACT

A portable device is capable of automatically determining if the portable device is moving and achieving a specific function with a button-free procedure. The portable device includes an embedded microprocessor and an acceleration detector. The acceleration detector can determine if the portable device is moving by detecting a vibration of the portable device and thus prohibit the portable device from entering the locked mode. In addition, when the portable device is moving or inclining with specific sequential operations by the effect of an external force, the acceleration detector can generate a sensing signal and the microprocessor can obtain a specific command in response to the comparison between the sensing data and a sample database, so that the microprocessor can achieve the specific function.

### FIELD OF THE INVENTION

The present invention is related to a portable device, and more particularly to a portable device for achieving a specific function with a button-free procedure, so as to provide the user with a ready and convenient maneuverability in operating the portable device.

### BACKGROUND OF THE INVENTION

With the burgeoning development of the telecommunication technology, the devices that are on the cutting edge of the development trend of portable product, such as the mobile phone and personal digital assistant (PDA), have served indispensable implements in modern life. In order to push the market share of the portable products, the industrialists have successfully endeavored to provide their portable devices with an excellent versatility and facility with intent to draw more attention of consumers.

Generally speaking, a typical portable device is set to automatically enter the locked mode when it is idled for a certain period of time. Meanwhile, if the user desires to use the portable device, the user is required to depress specific pushbuttons or input a specific password to unlock the portable device. The above-mentioned auto-lock mechanism is devised for protecting the data retained in the portable device from dissemination when the user is far away from the portable device for a long time or loses the portable device. However, as is often the case that when the user desires to use the portable device which has been idled for a long time, the portable device has been placed under the locked mode, and the user has to waste some time depressing pushbuttons to unlock the portable device. This would result in a sharp deterioration in the convenience of the portable device.

Furthermore, when the user is operating a portable device to achieve a certain function, the user has to follow the steps prescribed by the product vendor to sequentially depress the pushbuttons mounted on the portable device, so that a specific function, such as power-on or power-off can be completed. Furthermore, the product vendor normally adopts an improved user interface design by predefining a hotkey or speech control means to facilitate the user operation in order to simplify the operation steps and decrease the times of depressing the pushbuttons. In this manner, the user can handle the portable device to achieve a specific function mode. Furthermore, for the sake of data security, the user is urged to set a start-up password on the portable device. If the user desires to drive the portable device into the startup mode, the user is required to input the password for user authentication.

The aforementioned portable device has simplified the procedure of user interface operation. Nonetheless, the user is still required to depress the pushbuttons for inputting password or depress the hotkeys corresponding to a variety of specific function modes. Such operation procedure is awkward and the data security mechanism is vulnerable to be cracked down by illegitimate users.

Even if the hotkey means is replaced by a speech control means to fulfill the lock/unlock mechanism, the speech control means is susceptible to the outside noise and interference. In this manner, the portable device is prone to misjudge the commands issued by the user due to the limited accuracy of speech recognition, and thus such voice-controlled portable device is disobedient to modern praxiology.

### SUMMARY OF THE INVENTION

Therefore, a major topic of the present invention has been targeted at the drawbacks of the user operations encountered by the prior art portable device. To this end, the present invention designs a portable device capable of automatically determining if the portable device is moving. As long as the portable device is moving, the portable device is prohibited from entering the locked mode. Otherwise, the portable device is forced to automatically enter the locked mode after a predetermined period of time.

The portable device proposed by the present invention is advantageous in that a specific function of the portable device is achieved with a button-free procedure, so that the user can facilitate the operation procedure. The portable device can provide the user with a more convenient operating interface, and evade the interferences stemming from the outside environment.

A primary object of the present invention is to provide a portable device capable of automatically determining if the portable device is moving by detecting the vibration of the portable device by an acceleration detector and detecting if the portable device is placed under a locked mode.

A secondary object of the present invention is to provide a portable device capable of achieving a specific function with a button-free procedure. The portable device includes an acceleration detector for detecting the desired function the portable device is requested to achieve. Therefore, the portable device is allowed to readily achieve a specific function without the need to contact a pushbutton.

Another yet object of the present invention is to provide a portable device capable of achieving a specific function with a button-free procedure. The user can readily and accurately issue a specific command intended to achieve a specific function without the use of pushbutton or speech control means. Thus, the interference stemming from the outside environment can be minimized, and the portable device is practicable to a variety of applications.

To fulfill the foregoing objects, the present invention provides a portable device with motion sensor, comprising at least one embedded microprocessor mounted within the portable device and electrically connected to an acceleration detector and a memory. The acceleration detector can detect if the portable device is placed under the effect of an external force and generate a sensing signal in response to the detection. The sensing signal is then transmitted to the microprocessor. If the microprocessor determines that the portable device is placed under vibration, the lock procedure is not performed to lock the portable device. If the microprocessor determines that the portable device is not placed under vibration, the portable device is automatically driven into a locked mode. Besides, the microprocessor also compares the sensing signal with the sample data within a sample database stored in the memory, and thereby enables the portable device to achieve a specific function mode.

The foregoing and features and advantages of the present invention will become more apparent through the following descriptions with reference to the accompanying drawings, in which:

### BRIEF DESCRIPTION OF THE DRAWINGS

FIG. 1A and FIG. 1B respectively show a three-dimensional view and a block diagram of the inventive portable device;

FIG. 2 is a plan view showing different postures of the inventive portable device;

FIG. 3A and FIG. 3B respectively show a plan view representing the inventive portable device moving in the X-axis direction and a characteristic diagram of the acceleration signal measured by the acceleration detector along the X-axis direction;

FIG. 4 is a plan view showing the moving track and spatial displacement of the inventive portable device in a three-dimensional coordinate space;

FIG. 5 is a flowchart illustrating the steps of generating the sample database; and

FIG. 6 is a flowchart illustrating the steps of manipulating the portable device.

### DETAILED DESCRIPTION OF THE PREFERRED EMBODIMENT

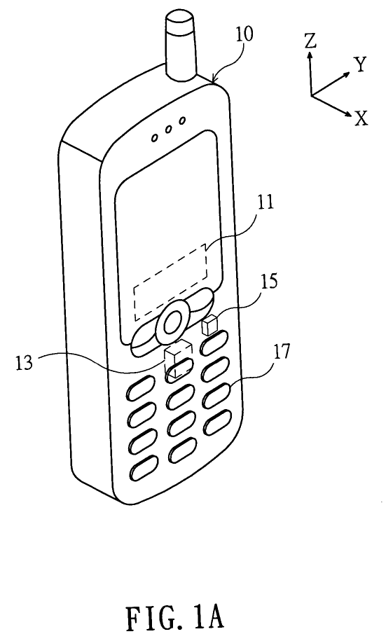

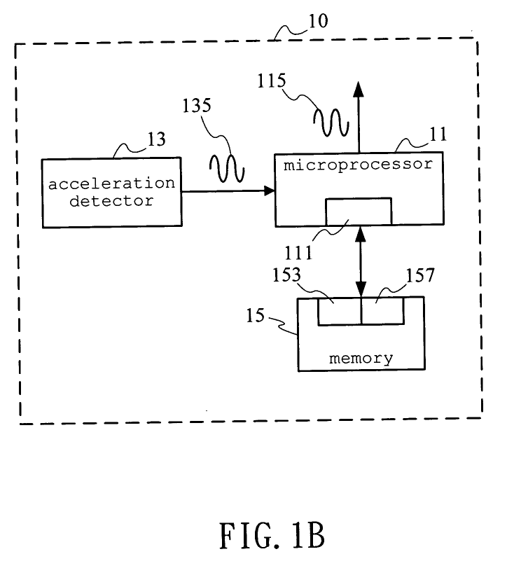

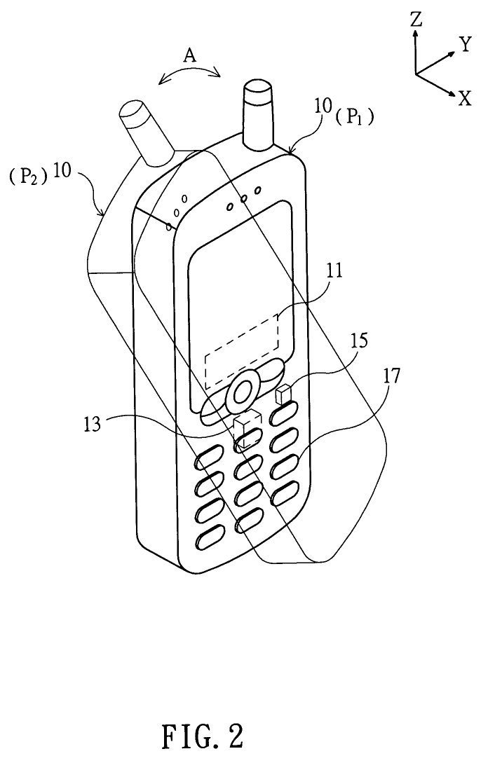

Referring to FIG. 1A, FIG. 1B and FIG. 2, which represent a three-dimensional view, a block diagram and a plan view showing different postures of the portable device according to a preferred embodiment of the present invention. As shown in these diagrams, the inventive portable device 10 basically includes an embedded microprocessor 11 and a plurality of pushbuttons 13, wherein the microprocessor 11 is electrically connected to an acceleration detector 13 and a memory 15. The acceleration detector 13 is configured for the detection of the spatial displacement and the angular transition of the portable device 10, and is capable of generating a sensing signal 135 in response to the detection. The microprocessor 11 determines if the sensing signal 135 is a stable signal or a bouncing signal. If the sensing signal 135 is determined to be a stable signal, the portable device 10 is acknowledged to be free from the effect of any external force, and a countdown procedure is begun to drive the portable device 10 into a locked mode. If the sensing signal 135 maintains stable within a predetermined period of time, the portable device 10 is forced to automatically enter the locked mode (and/or power-saving mode). When the portable device 10 does not enter the locked mode (and/or power-saving mode), the acceleration detector 13 can cancel the countdown procedure when a vibration of the portable device 10 as a result of the effect of an external force is detected. That is, if there is a bounce occurring in the sensing signal 135 during countdown, the countdown procedure is cancelled and can be resumed until the sensing signal 135 becomes stable again.

When the portable device 10 enters the locked mode (and/or power-saving mode), the user is required to input the password by pushbuttons or enable the portable device 10 to perform specific sequential operations to relinquish the locked mode. Also, the portable device 10 can be wakened up by vibrations as a result of the effect of an external force when the portable device 10 lingers in the powers-saving mode. The details of implementing the technique of the unlocking portable device 10 by specific sequential operations will be given in the following.

The portable device 10 can change its inclination and acceleration by the effect of an external force A. The acceleration detector 13 is capable of detecting the postural transition and the spatial displacement of the portable device 10, and generating a sensing signal in response to the detection for output to the microprocessor 11. Upon the receipt of the sensing signal, the microprocessor 11 converts the sensing signal into a behavior data 111 and compares the behavior data 111 with the unlocking data 153 stored in the memory 15. If the behavior data 111 matches with the unlocking data 153, the locked mode of the portable device 10 is relinquished. Otherwise, the locked mode of the portable device is sustained.

In addition to the technique of unlocking the portable device 10 by specific sequential operations, the present invention can establish a command input mechanism in terms of specific sequential operations. First, the user is prompted to perform specific sequential operations to the portable device. The acceleration detector 13 then detects the specific sequential operations and generates a sensing signal 135 in response to the detection. Next, the sensing signal 135 is transmitted to the microprocessor 11 for processing and a behavior data 111 is generated thereby. The memory 15 contains an internal sample database 157 comprising sample data provided for the microprocessor to perform data comparison. Each sample data involved in the sample database 157 corresponds to a specific command 115, and each specific command 115 enables the portable device 10 to achieve a corresponding specific function mode. That is, the user can enable the portable device 10 to execute the specific command 115 by entering specific sequential operations accompanied with data comparison process so that the portable device can enters a corresponding specific function mode.

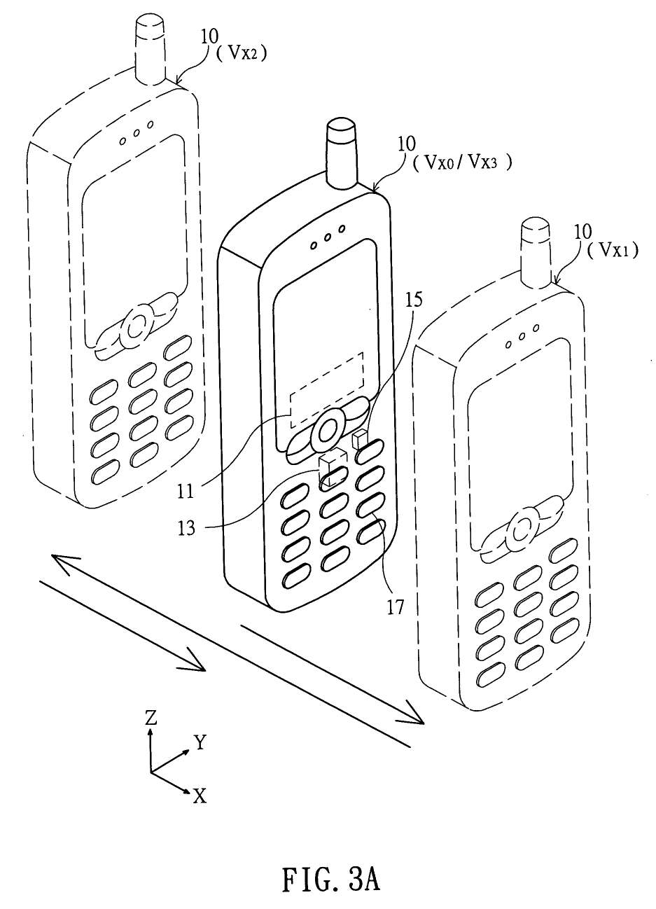

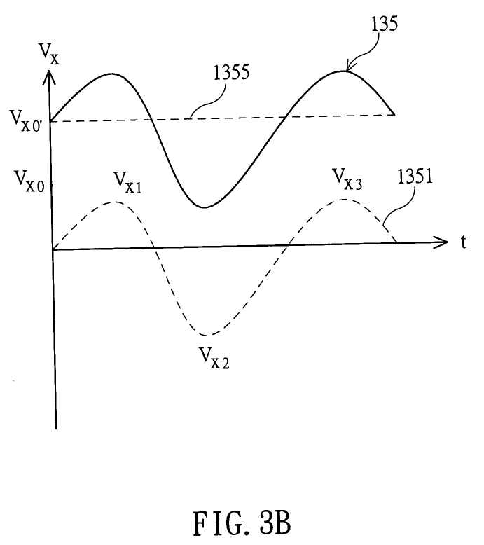

While the effect of the external force A induces a spatial displacement of the portable device 10, the acceleration detector 13 detects the accelerative transition or angular transition of the portable device 10 (this can be done by the component of the acceleration vector that is resulted from the gravity field), and generates an acceleration signal 1351 as shown in FIG. 3B and an inclination signal Vₓ₀ 1355 as shown in FIG. 3B. That is, the sensing signal 135 is constituted by the acceleration signal 1351 and/or the inclination signal 1355. With reference to the inclination signal, the portable device 10 can make different components of the gravitational vector when it is posed with different inclinations. For example, the inclination signals with respect to the X-axis and measured when the portable device 10 is posed with the first posture P1 and with the second posture P2 as shown in FIG. 2 are V_{X0} and V_{X0′}, respectively. When the portable device 10 is moved with a fixed inclination, the inclination signal 1355 is a constant, as shown in FIG. 3B.

Also, the acceleration detector 13 can alternatively detect the transition of the spatial displacement or inclination of the portable device 10 in a one-dimensional coordinate space, a two-dimensional coordinate space or a three-dimensional coordinate space, so that the acceleration detector 13 can alternatively generate a one-dimensional acceleration signal, a two-dimensional acceleration signal, or a three-dimensional acceleration signal, and a one-dimensional inclination signal, a two-dimensional inclination signal, or a three-dimensional inclination signal, and thereby compose sample data with a great complexity through combination. This would significantly enhance the data security for the portable device.

Further, referring to FIG. 2, FIG. 3A and FIG. 3B, a plan view representing different posture of the inventive portable device, a plan view representing the inventive portable device moving in the X-axis direction, and a characteristic diagram of the acceleration signal measured by the acceleration detector along the X-axis direction are respectively shown. As shown in these diagrams, assuming the user poises the portable device 10 with a first posture P1, an inclination signal V_{X0} can be detected along the X-axis direction. Next, the portable device 10 is posed with a second posture P2 by the effect of the external force A, and a sensing signal V_{X0′} is measured. Next, the portable device 10 moves in the positive direction along the X-axis and a sensing signal V_{X1} is measured. The portable device 10 subsequently moves in the negative direction along the X-axis and a sensing signal V_{X2} is measured. Eventually, the portable device 10 moves back to its original position and a sensing signal V_{X3} is measured.

Certainly, the acceleration detector 13 is set to remain in the status of continuous detection. Therefore, the measured sensing signal 21 is a continuous signal. The curvature of the turning points of the sensing signal V_{X1}, V_{X2} and V_{X3} are associated with the rate of variation in the strength of the external force. The slower the strength of the external force is varying, the smaller the curvature of the turning points of the sensing signals is. Also, the amplitude of the curves of the sensing signals is associated with the strength of the external force. Hence, the slope of the curves of the sensing signals is associated with the strength of the external force. That is, the larger the acceleration of the portable device is, the larger the slopes of the curves of the sensing signal is, and vice versa. Accordingly, the curvatures of the turning points, the amplitude of curves, and the slope of the curves can reflect the status of the external force, and a variety of combinatorial formulas can represent a specific function desired to be achieved.

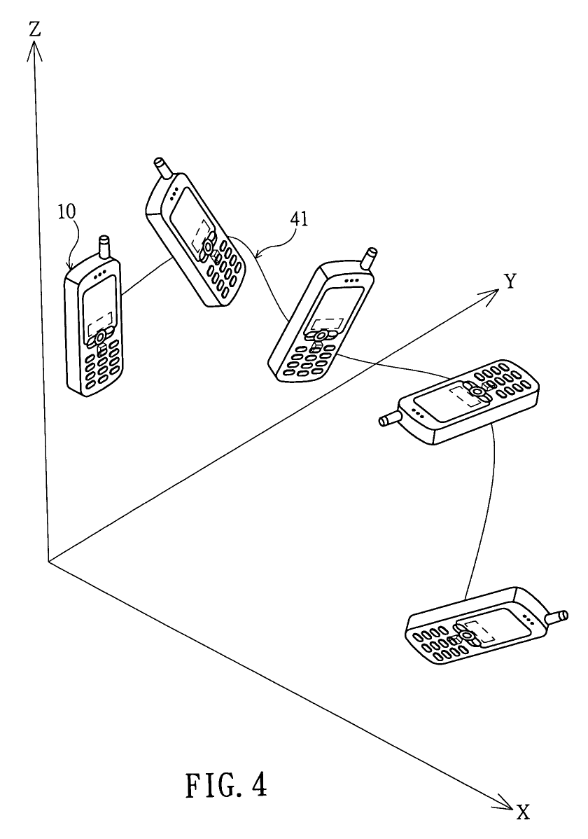

Likewise, the acceleration detector 13 can detect the movement and spatial displacement of the portable device 10 along the Y-axis and the Z-axis direction under the effect of the external force A, and therefore the displacement status of the portable device 10 under the effect of the external force A can be obtained in a three-dimensional scale. Further, the transition of the moving track and the angular transition of the portable device can be ascertained, as shown in FIG. 4. Certainly, the embodiment of FIG. 4 simply demonstrates an example that the portable device 10 follows the track 41 to make spatial displacement along with angular transition. In fact, the acceleration detector 13 can generate different detection result according to the diversity of the movement mode (the variation of moving speed). Therefore, the user can drive the acceleration detector 13 to generate a sensing signal with a greater complexity as desired, and thereby establish a compound sample database 157. In this way, even if a third party can observe the moving track 41 of the portable device 10 when the user is performing specific sequential operations to the portable device, the strength of the external force is not possible to be aware of by an onlooker. Therefore, even if a third party can manipulate the portable device 10 in compliance with the same moving track, he/she is not possible to achieve any specific function mode on the portable device 10.

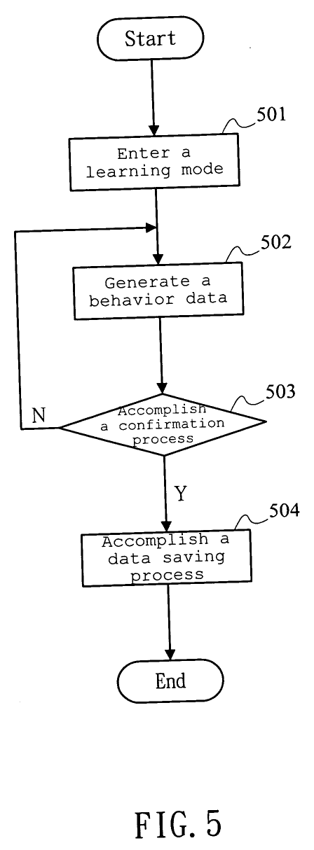

Referring to FIG. 5, the procedure of establishing the sample database is illustrated. The procedure of FIG. 5 includes the following steps:

Step 501: Enter a learning mode. The user can preset the portable device to enter a learning mode corresponding to a specific function mode of the portable device. Certainly, the learning mode can be a built-in function of the portable device.

Step 502: Generate a behavior data. The user is required to perform specific sequential operations to the portable device as described above, and thus enable the portable device to make spatial displacement with different postures, along the moving track as shown in FIG. 4 for example. The acceleration detector then generates a sensing signal in response to the specific sequential operations and transmits the sensing signal to the microprocessor. The microprocessor then converts the sensing signal into a behavior data corresponding to the selected specific function mode entered in step 501.

Step 503: Accomplish a confirmation process. The behavior data generated in step 502 is required to be confirmed by the user and the behavior data is correlated to a specific command for achieving the specific function mode, thereby confirm if the specific command or specific sequential operations represent a desired specific function mode. For example, the specific command or specific sequential operations can represent a power-on mode, a power-off mode, a call reception mode, a speed dial mode, a caller ID display mode, a vibration alert mode, an address book mode, or a personal data mode. If the result of the confirmation process is positive, the procedure continues with step 504. Otherwise, step 502 is re-executed; and

Step 504: Accomplish a data saving process. The behavior data is saved in the memory and serves as the sample data corresponding to the selected specific function mode entered in step 501.

The user may repeat steps 501 to 504 to collect the sample data corresponding to a variety of specific function modes, and thereby establish a sample database.

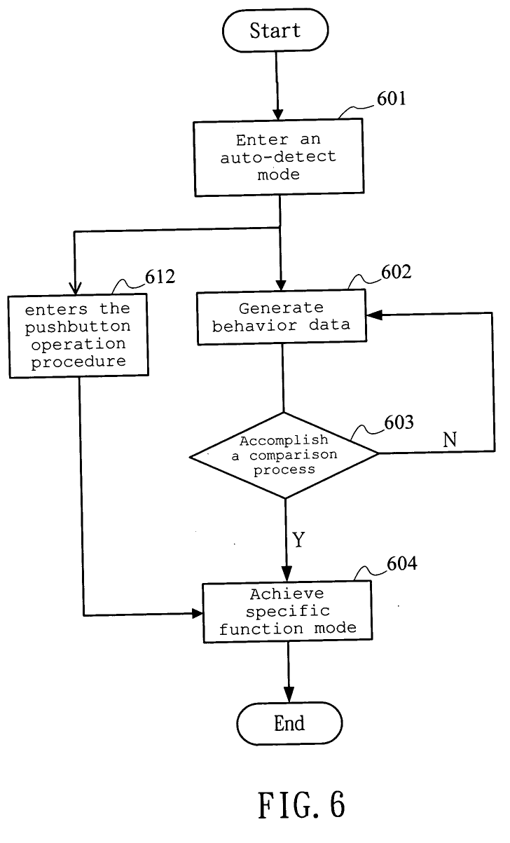

Finally, referring to FIG. 6, the manipulation method of the portable device is illustrated. As shown in FIG. 6, the manipulation method of the portable device includes the following steps:

Step 601: Enter an auto-detect mode. The portable device 10 can automatically detect if the user implements the command input mechanism with specific sequential operations or pushbuttons;

Step 602: Generate behavior data. For example, the user may perform specific sequential operations to the portable device in step 601 and thus enable the acceleration detector to generate a sensing signal with respect to the moving track. The sensing data is then transmitted to the microprocessor and converted into a behavior data corresponding to the specific sequential operations;

Step 612: This step represents that the portable device detects that the pushbutton has been activated and enters the pushbutton operation procedure. The user is required to depress pushbuttons to achieve a specific function mode, which is as similar as the prior art described above.

Step 603: Accomplish a comparison process. The behavior data is compared with the sample data stored in the sample database to check if the behavior data matches with at least one sample data within the sample database. If the result of the comparison process is positive, the procedure continues with step 604. Otherwise, step 602 is re-executed.

Step 604: Achieve specific function mode. If the user accurately performs specific sequential operations to the portable device, a corresponding command can be retrieved. Therefore, the portable device can achieve the specific function mode as specified by the corresponding specific command.

With the design described above, the user can readily operate the portable device to achieve a specific function mode without the need to contact a pushbutton. The inventive portable device is practicable to a variety of applications, and is capable of lessening the effect of the outside noise and interference. Alternatively, the portable device can be a mobile phone, a PDA, a MP3 player, a MP4 player, a voice recorder, or a telecommunication device.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A portable device with a motion sensor, comprising:
an embedded microprocessor; and
an acceleration detector electrically connected to said microprocessor for generating a sensing signal in response to said effect of an external force, said sensing signal converted into a behavior data by said microprocessor;
wherein if said sensing signal maintains stable within a predetermined period of time, said microprocessor drives said portable device into a locked mode.

2. The portable device with a motion sensor according to claim 1, further comprising a memory for storing unlocking data, wherein if said behavior data matches with said unlocking data, said microprocessor unlocks said portable device.

3. The portable device with a motion sensor according to claim 2, wherein said sensing signal is an acceleration signal, an inclination signal, or a combination of an acceleration signal and an inclination signal.

4. A portable device with a motion sensor, comprising:
an embedded microprocessor;
an acceleration detector electrically connected to said microprocessor for detecting if said portable device is placed under said effect of an external force and in response thereto generating a sensing signal; and
a memory electrically connected to said microprocessor for storing a sample database comprising at least one sample data;
wherein said microprocessor converts said sensing signal into a behavior data and compares said behavior data with said sample data within said sample database, and if said behavior data matches with at least one sample data within said sample database, said microprocessor achieves a specific function mode corresponding to said sample data.

5. The portable device with a motion sensor according to claim 4, wherein said sensing signal is an acceleration signal, an inclination signal, or one of the combination thereof.

6. The portable device with a motion sensor according to claim 5, wherein said sensing signal is a one-dimensional acceleration signal, a two-dimensional acceleration signal, or a three-dimensional acceleration signal.

7. The portable device with a motion sensor according to claim 5, wherein said sensing signal is a one-dimensional inclination signal, a two-dimensional inclination signal, or a three-dimensional inclination signal.

8. The portable device with a motion sensor according to claim 4, wherein said sample database is established in a learning mode.

9. The portable device with a motion sensor according to claim 4, wherein said specific function mode is a power-on mode, a power-off mode, a call reception mode, a speed dial mode, a caller ID display mode, a vibration alert mode, an address book mode, a personal data mode, or one of the combination thereof.

10. The portable device with a motion sensor according to claim 4, wherein a plurality of pushbuttons is mounted on said portable device.

11. The portable device with a motion sensor according to claim 4, wherein said portable device is a mobile phone, a PDA, a MP3 player, a MP4 player, a voice recorder, a telecommunication device, or one of the combination thereof.

12. A method for automatically locking a portable device with a motion sensor, comprising the steps of:
detecting if said portable device is placed under said effect of an external force by an accelerator detector, and in response thereto generating a sensing signal; and
if said sensing signal is maintained stable within a predetermined period of time, driving said portable device to enter a specific mode.

13. The method for automatically locking a portable device with a motion sensor according to claim 12, wherein said specific mode is a locked mode or a power-saving mode.

14. The method for automatically locking a portable device with a motion sensor according to claim 13, further comprising the steps of:
when said portable device enters said specific mode, check if said sensing signal matches with an unlocking data stored in a memory; and
if said sensing signal matches with said unlocking data, relinquish said specific mode.

15. The method for automatically locking a portable device with a motion sensor according to claim 13, further comprising the steps of:
when said portable device enters said specific mode, determining whether an input signal matches with an unlocking password stored in a memory; and
if said input signal matches with said unlocking password, relinquish said specific mode.
